(19) United States
(12) Patent Application Publication
(10) Pub. No.: US 2023/0154631 A1
(43) Pub. Date: May 18, 2023

(54) METHOD AND APPARATUS FOR CONTROLLED FUSION REACTIONS

(71) Applicant: Alpha Ring US Inc., Monterey, CA (US)

(72) Inventors: Luo-Chuang LEE, New Taipei City (TW); Kun-Han LEE, Taipei City (TW); Dongdong NI, Taipa (MO)

(21) Appl. No.: 17/961,636

(22) Filed: Oct. 7, 2022

Related U.S. Application Data
(60) Provisional application No. 63/255,382, filed on Oct. 13, 2021.

(51) Int. Cl. G21B 1/11

(52) U.S. Cl. CPC G21B 1/11

(57) ABSTRACT

A method and an apparatus are provided for performing a fusion reaction. The method comprises providing neutral gas within a gas chamber, supplying energy to the gas chamber to initiate heating of a cathode and ionization of the neutral gas into protons and electrons, causing formation of a conducting channel due to the ionized neutral gas, causing formation of an electron layer outside the cathode based on set of thermionically emitted electrons by the heated cathode, causing acceleration of the electrons towards the cathode to cause the heated cathode to emit a set of secondary electrons due to a potential associated with the electron layer. The set of secondary electrons enhance strength of the electron layer. The method comprises causing formation of an electrostatic potential profile with dips and peaks, due to an electron-ion two-stream instability. The protons are accelerated towards the cathode at peaks and bombardment of the protons into the cathode enables fusion reaction.

### TECHNOLOGICAL FIELD

The present disclosure relates to nuclear reactions and reactors. In particular, the present disclosure relates to compact fusion reactors for initiating and maintaining fusion reactions.

### BACKGROUND

With increased population, increased urbanization and expanding access to electricity in developing countries, demand of energy is expected to grow manifolds. Moreover, in recent years, due to depleting reserves of conventional energy resources and severe impact on the environment due to green-house gasses released form conventional energy resources, it is crucially important to ensure reduced green-house gas emissions during energy generation. Therefore, there is a need for exploring alternate large-scale, sustainable, and carbon-free form of energy resources.

Fusion energy has been identified as an ideal future energy owing to carbon-free base-load electricity production, no long-lived radioactive waste, sustainable fuels, and reduced safety threats. As a result, fusion energy may make positive contribution to the energy sector as well as the environment. Nuclear fusion is a process that occurs when two atoms combine to make a larger atom, creating energy. Controlled fusion reactions have been performed for decades, however, the goal is to make a fusion reactor that produces more energy than it takes in, i.e., high net gain.

Prior efforts in large-scale fusion research have primarily focused on two methods of creating conditions for fusion ignition: inertial confinement fusion (ICF) and magnetic confinement fusion. ICF attempts to initiate a fusion reaction by compressing and heating fusion reactants, such as a mixture of deuterium (²H) and tritium (³H), in the form of a small pellet and energizing the fuel by delivering high-energy beams of, for example, laser light, electrons, or ions to the fuel. However, time duration of such ICF fusion is very short, and excess heat may have to be removed from a reaction chamber without interfering with the fuel targets and driver beams, thereby making ICF an unsustainable reaction. The magnetic confinement attempts to induce fusion by using magnetic fields to confine hot fusion fuel in the form of plasma. Magnetic fusion devices apply a magnetic force on charged particles in a manner that serves as a centripetal force, causing the particles to move in circular or helical path within the plasma. Most of the research in magnetic confinement is based on, for example, Tokamak design in which hot plasma is confined within a toroidal magnetic field. However, such tokamak reactors also failed to achieve a high net power gain of energy in terms of output energy and input energy in order to use fusion reaction as a sustainable energy source. To this end, all the credible prior approaches have faced confinement and engineering issues.

In practice, only a portion of output fusion energy of a fusion reactor can be converted to a useful form. Conventional thinking holds that only strongly ionized plasmas that do not have significant quantities of neutrals may be advantageous. The strongly ionized plasmas limit particle densities and energy confinement times that can be achieved in the fusion reactor. Thus, in certain experimental set-ups Lawson criterion is used as a benchmark for controlled fusion reactions.

A common formulation of the Lawson criterion, known as the triple product, is as follows:

$$nT {τ}_{E} > \frac{12 {k}_{B}}{{E}_{ch}} \frac{{T}^{2}}{〈 σ v 〉}$$

In particular, the Lawson criterion states that a product of a particle density (n), temperature (T), and confinement time (τ_{E}) must be greater than a number dependent on the energy of the charged fusion products (E_{ch}), the Boltzmann constant (k_{B}), the fusion cross section (σ), the relative velocity (v), and temperature in order for ignition conditions to be reached. For the deuterium-tritium reaction, a minimum of a triple product occurs at k_{B}T=14 keV and the number for the triple product is about 3×10²¹ keV s/m³. In order to satisfy Lawson criterion, fusion reactors are constructed that are large, complex, difficult to manage, expensive, and, as yet, economically unviable. In practice, temperatures in excess of 150,000,000 degrees Celsius are required to achieve positive energy balance using a D-T fusion reaction. For a proton-boron based fusion reaction, the Lawson criterion suggests that a required temperature must be yet substantially higher. As the conventional thinking holds that high temperatures and strongly ionized plasma are required for sustainable fusion reaction, inexpensive physical containment of atoms for fusion reaction is difficult. Therefore, designing of the fusion reactor based on Lawson criterion may not be feasible.

Multiple approaches have been proposed to capture the energy produced by the nuclear fusion reaction. One such approach is aneutronic fusion using proton and boron. Recently, proton-boron (p-¹¹B) nuclear fusion reaction has become attractive because boron is more abundant in nature and easy to handle. Moreover, fusion power from proton-boron (p-¹¹B) nuclear fusion reaction is released mainly in charged α particles rather than neutrons, hence, the proton-boron nuclear fusion reaction is also known as aneutronic reaction. The aneutronic proton-boron nuclear fusion reaction can be written as:

p+¹¹B→3⁴He+8.68 MeV (1)

As shown above, the aneutronic proton-boron nuclear fusion reaction may produce three ⁴He and release energy of 8.68 MeV, and no neutrons are produced. Owing to aneutronic reaction or substantially aneutronic reaction, such energy is clean.

In a nuclear fusion reaction, a fusion reaction rate R may be estimated by the expression:

R=n₁n₂ [symbol] σu [symbol] (2)

Where n₁ and n₂ are reactant densities, σ is a fusion cross section, and u is velocity. The average term [symbol] σu [symbol] is called reactivity. In certain conventional fusion techniques, super thermal plasma aims to increase the reaction rate, i.e., reaction rate is increased by increasing temperature of the plasma. To this end, it has been a challenge to find a way to sustain a fusion reaction in a way that is economical, safe, reliable, and environmentally sound.

Therefore, there is a need to overcome drawbacks, for example, requirement of increased reaction rate, higher power gain and lower temperature requirement, associated with the conventional fusion reactions, especially conventional proton-boron based fusion reaction. In particular, there is a need to develop a fusion reactor that generates more fusion power such that fusion energy can become a commercially viable source of energy.

### SUMMARY

A method and an apparatus are provided herein for performing a controlled fusion reaction. In one aspect, the method for performing the controlled fusion reaction comprises providing a neutral gas within a gas chamber, the gas chamber comprising an anode and a cathode and neutral gas dispersed within the gas chamber. In accordance with an embodiment, the method comprises supplying energy to the gas chamber. The supplying of the energy initiates at least: heating of the cathode, and ionization of the neutral gas into protons and electrons. In accordance with an embodiment, the method comprises causing formation of a conducting channel, due to the ionized neutral gas. In accordance with an embodiment, the method comprises causing formation of an electron layer outside an outer surface of the cathode, based on a set of thermionically emitted electrons by the heated cathode. In accordance with an embodiment, the method comprises causing acceleration of the electrons from the ionized neutral gas towards the cathode, due to a potential associated with the electron layer, to cause the heated cathode to emit a set of secondary electrons. The set of secondary electrons enhance a strength of the electron layer. In accordance with an embodiment, the method comprises causing formation of an electrostatic potential profile within the conducting channel due to an electron-ion two-stream instability. The electrostatic potential profile comprises a plurality of dips and a plurality of peaks. The protons from the ionized neutral gas are accelerated towards the cathode at the plurality of potential peaks and bombardment of the accelerated protons into the cathode enables the controlled fusion reaction.

According to some example embodiments, the method further comprises causing an initial discharge current to heat the cathode and ionize the neutral gas and causing formation of a first potential dip of the plurality of potential dips due to the set of thermionically emitted electrons emitted by the heated cathode.

According to some example embodiments, the method further comprises causing acceleration of the electrons between a region associated with the first potential dip and the cathode to bombard the cathode. The region lies between the anode and the cathode. In accordance with an embodiment, the method further comprises causing emission of the set of secondary electrons, due to the bombardment of the accelerated electrons at the cathode. In accordance with an embodiment, the method further comprises causing strengthening of the electron layer, at the first potential dip of the plurality of potential dips, due to the set of secondary electrons emitted by the cathode. In accordance with an embodiment, the method further comprises causing formation of the electrostatic potential profile within the conducting channel, due to the strengthened electron layer, the conducting channel with the electrostatic potential profile being associated with the formation of the enhanced electron layer and the strengthened first potential dip.

According to some example embodiments, the method further comprises causing emission of the set of thermionically emitted electrons, due to the heating of the cathode. The set of thermionically emitted electrons are emitted from the surface of the cathode into the region associated with the first potential dip. In accordance with an embodiment, the method further comprises causing formation of the electron layer having a negative charge density locally outside the surface of the cathode.

According to some example embodiments, the method further comprises supplying energy to the gas chamber to partially ionize the neutral gas to generate plasma. The plasma comprises the protons, the electrons, positive ions, and negative ions. In accordance with an embodiment, the method further comprises causing the electrons and the negative ions to accelerate towards the cathode to cause the bombarded cathode to emit the set of secondary electrons.

According to some example embodiments, the method further comprises causing formation of a region of the first potential dip outside the cathode of the gas chamber, due to the enhanced strength of the electron layer. The region of the first potential dip has a minimum potential value at a center of the electron layer. A first electric field is directed from the cathode towards the center of the electron layer, and a second electric field is directed from the anode towards the center of the electron layer.

According to some example embodiments, the method further comprises causing acceleration of negative charges and positive charges. The negative charges comprise the electrons and the negative ions, and the positive charges comprise the protons and the positive ions. The negative charges are accelerated from the cathode towards the anode and the positive charges are accelerated from the anode towards the cathode. The positive charges and the negative charges are accelerated in opposite directions and have a velocity difference. In accordance with an embodiment, the method further comprises causing the electron-ion two-stream instability within the gas chamber, due to the velocity difference between the positive charges and the negative charges.

According to some example embodiments, the method further comprises causing acceleration of the negative charges towards the cathode, at each of the plurality of dips, to cause the cathode to emit the set of secondary electrons. In accordance with an embodiment, the method further comprises causing acceleration of the positive charges towards the cathode, at each of the plurality of peaks, to bombard into the cathode, wherein the bombardment of the accelerated protons and the positive ions into the cathode occurs with a kinetic energy.

According to some example embodiments, the kinetic energy of each charged particle bombarding into the cathode is in a range of 1 keV to 100 keV.

According to some example embodiments, the method further comprises applying a heating source across the gas chamber to perform at least: the heating of the cathode, and ionization of the neutral gas into the protons and the electrons. In accordance with an embodiment, the heating source comprises at least one of: superconducting magnet source, permanent magnet source, electromagnet source, radiofrequency (RF) source, microwave source, electric field source, electrode source, laser source, ion gun source, or a combination thereof.

According to some example embodiments, a diameter of the conducting channel is in a range of 0.01 millimeters to 1 millimeter.

According to some example embodiments, a density of the neutral gas is in a range of 1×10²⁰ to 1×10²⁵ m⁻³.

According to some example embodiments, the neutral gas comprises at least hydrogen (H₂) gas.

According to some example embodiments, the gas chamber is energized by externally applying a voltage in a range of 10 Volts to 1000 Volts.

According to some example embodiments, the cathode comprises a boron rich material. The boron-rich material comprises at least one of: lanthanum hexaboride (LaB₆), cerium hexaboride (CeB₆), lithium boride, pure boron, or boron nitride. In accordance with an embodiment, the cathode provides boron for the controlled fusion reaction.

Embodiments disclosed herein may provide an apparatus for performing a controlled fusion reaction. The apparatus comprises a gas chamber comprising an anode and a cathode enclosed within the gas chamber, and a neutral gas distributed within the gas chamber. The apparatus further comprises an energy source configured to supply energy to the gas chamber. In accordance with an embodiment, the supply of the energy causes to initiate at least: heating of the cathode, and ionization of the neutral gas into protons and electrons. In accordance with an embodiment, the supply of the energy causes to form a conducting channel, due to the ionized neutral gas. In accordance with an embodiment, the supply of the energy causes to form an electron layer outside an outer surface of the cathode, based on a set of thermionically emitted electrons by the heated cathode. In accordance with an embodiment, the supply of the energy causes to accelerate the electrons from the ionized neutral gas towards the cathode, due to a potential associated with the electron layer, to cause the heated cathode to emit a set of secondary electrons. The set of secondary electrons enhance a strength of the electron layer. In accordance with an embodiment, the supply of the energy causes to form an electrostatic potential profile in the conducting channel due to an electron-ion two-stream instability. The electrostatic potential profile has a plurality of dips and a plurality of peaks. The protons from the ionized neutral gas are accelerated towards the cathode at the plurality of potential peaks and bombardment of the accelerated protons into the cathode enables the controlled fusion reaction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a diagram of a gas chamber for facilitating a fusion reaction, in accordance with an example embodiment;

FIG. 2 shows a flowchart depicting steps of a method for performing a controlled fusion reaction, in accordance with an example embodiment;

FIG. 3 illustrates a graph depicting flow of electron at a first potential dip, in accordance with an example embodiment;

FIG. 4 illustrates a graph depicting an electrostatic potential profile, in accordance with an example embodiment;

FIGS. 5A-5F illustrates example graphical representation of an energy distribution of accelerated protons, in accordance with an example embodiment;

FIGS. 6A-6C illustrate simulation results corresponding to potential peaks and potential dips, in accordance with an example embodiment; and

FIG. 7 illustrates an example flowchart depicting steps of a method for performing a controlled fusion reaction in a gas chamber, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. Thus, use of any such terms should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

Throughout the present disclosure, the term “fusion” refers to a nuclear reaction that occurs when the nuclei of two or more atoms combine, whereby the combined nucleus has a mass number less than or equal to that of ⁶²Ni. By this definition, the combined nucleus is unstable, and will thus release its excess energy by decaying, typically into multiple product nuclei, with the possible inclusion of neutrons. Particularly, the total mass of the products is smaller than the combined mass of the reactants. The difference in the mass is released as energy in accordance with Einstein's equation E=mc². The energy obtained from fusion reaction is based on differences in nuclear binding energy. As the speed of light in vacuum, ‘c’, is very large, a small amount of missing mass turns into a large amount of energy. Pursuant to present disclosure, the term “fusion” is used interchangeably with “fusion reaction” and “nuclear fusion”.

Throughout the present disclosure, the term “aneutronic fusion” refers to a form of fusion reaction in which very little of the released energy from fusion reaction is carried by neutrons. The energy released in the aneutronic fusion reaction is in the form of energetic charged particles, typically protons or alpha particles. Pursuant to embodiments of the present disclosure, the aneutronic fusion reaction may be performed by fusing nuclei of a proton and boron. The proton-boron aneutronic fusion reaction releases its energy in the form of energetic alpha particles without producing neutrons, thereby making the released energy cleaner and easier to use.

Throughout the present disclosure, the term “fusion reactor” refers to a device or an apparatus or a system for producing energy (or fusion energy) released in a fusion reaction. The term “fusion reactor” is used interchangeably with “fusion power plant”.

Throughout the present disclosure, the terms “ion”, “ionized atom” or “charged particle” refer to an atom or a particle having at least one more electron than a total number of proton(s) or having at least one more proton than a total number of electron(s).

Throughout the present disclosure, the terms “neutral species” or “neutrals” refer to atoms or molecules with a neutral charge. In particular, a neutral atom may have a same number of electrons and protons, i.e., corresponding to its atomic number.

Throughout the present disclosure, the term “cathode” refers to a negatively charged or grounded electrode. Moreover, the term “anode” refers to a positively charged electrode. Pursuant to present disclosure, the cathode is made of a boron-rich material, for example, Lanthanum hexaboride (LaB₆).

Throughout the present disclosure, the term “gas chamber” refers to an enclosing for a gas. Pursuant to present disclosure, the gas chamber is filled with a neutral gas and the gas chamber also encloses a cathode and an anode. In this regard, the gas chamber may use electrical energy to facilitate a non-spontaneous ionization of the neutral gas inside the gas chamber. For example, the gas chamber may enclose the neutral gas, the cathode, and the anode for performing a fusion reaction.

Throughout the present disclosure, the term “plasma” refers to states of matter dispersed in a chamber. In the plasma, some electrons may have been stripped away from their atoms. As the particles (electrons and ions) in plasma have an electrical charge, the motions and behaviors of plasmas are affected by electrical and magnetic fields. The plasma is created when one or more electrons are torn free from an atom and/or an atom may capture one or more excess electrons. An ionized atom may be missing at least one electron, or the ionized atom may be stripped of electrons entirely leaving behind an atomic nucleus (of one or more protons and usually some neutrons). Atoms that are missing electrons are called “positive ions”. Positive ions may have a positive electrical charge because they have more positively charged protons than negatively charged electrons. Conversely, atoms that have excess of electrons are called “negative ions”. Negative ions may have a negative electrical charge because they have more negatively charged electrons than positively charged protons. The plasma is generally a mix of these positively charged ions or protons, negatively charged ions and electrons.

### End of Definitions

A method and an apparatus are provided herein in accordance with an example embodiment for initiating and maintaining a controlled fusion reaction. The method and the apparatus disclosed herein enables performing aneutronic fusion reaction for generating clean energy. The method and the apparatus disclosed herein enables initiation of the fusion reaction at a substantially lower temperature. The method and the apparatus disclosed herein enables commercial viability of fusion reaction such that produced fusion energy can be used for, for example, obtaining heat, generating electricity, and so forth. The method and the apparatus disclosed herein further enables design and construction of compact fusion reactors within which fusion reaction may occur. Such compact fusion reactors have reduced size and weight, are easy to handle, and have less complex design.

The method and the apparatus disclosed herein may provide a gas chamber for performing a fusion reaction. In an example, the gas chamber may include a cathode that may be grounded, an anode and gas dispersed within the gas chamber. In this regard, a voltage, i.e., electric energy is applied to the gas chamber for ionization of the gas within the gas chamber to form plasma and heat the grounded cathode within the gas chamber. Due to the ionization of the gas, a conducting channel may be formed between the cathode and the anode. Further, the heated cathode may cause thermionic emission of a set of thermionically emitted electrons. As a result, an electron layer may be formed outside an outer surface of the cathode. Further, due to a negative potential associated with the electron layer outside the cathode, electrons may be accelerated towards the cathode from the plasma. This may cause the heated cathode to further emit a set of secondary electrons. The set of secondary electrons may strengthen the electron layer by increasing a negative charge density thereof. The strengthened electron layer may cause electron-ion two-stream instability within the gas chamber that creates an electrostatic potential profile within the conducting channel. The electrostatic potential profile comprises a plurality of dips and a plurality of peaks. In this regard, protons (or positive charges) from the ionized neutral gas, i.e., the plasma, are accelerated towards the cathode at the plurality of potential peaks. Subsequently, the accelerated protons may bombard into the cathode to enable the controlled fusion reaction.

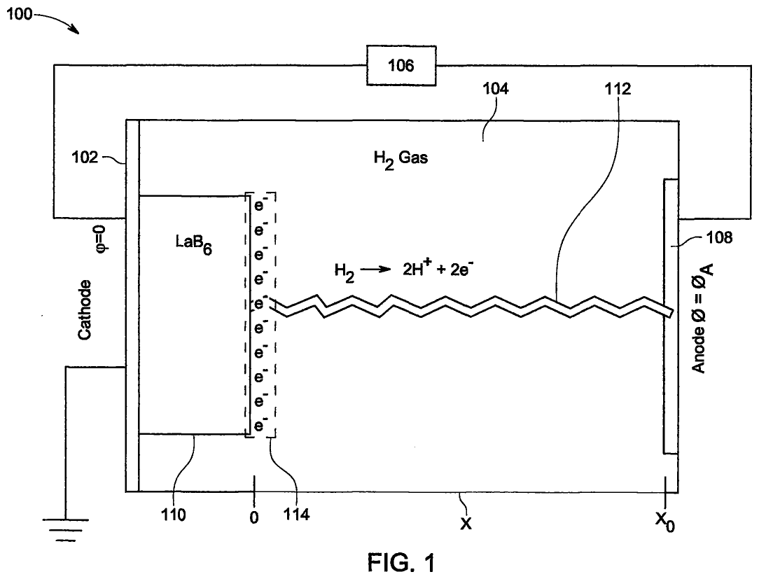

FIG. 1 illustrates a diagram of the apparatus 100 for initiating and maintaining a fusion reaction, according to embodiments of the present disclosure. According to embodiments of the present disclosure, the fusion reaction is initiated by supplying an electric potential and the fusion reaction is maintained by establishing a conducting channel having an electrostatic potential profile between a cathode and an anode. The conducting channel accelerates protons and electrons to bombard onto the cathode to perform nuclear fusion reactions.

The apparatus comprises a gas chamber 102. The gas chamber 102 comprises one or more chamber walls to form the enclosed gas chamber 102. In one embodiment, the gas chamber 102 is filled with a neutral gas 104. In this regard, the neutral gas 104 may be introduced by an inlet to achieve a required pressure. For example, the pressure within the gas chamber 102 may be in a range of 1 Millitorr (mTorr) to about 100 Torr. In accordance with an embodiment, the apparatus 100 further comprises an input power supply 106 for supplying electric energy to the gas chamber 102. For example, the power supply 106 may be a constant voltage source, a constant current source, or a constant power source.

The gas chamber 102 further comprises one or more anodes 108 at one end of the gas chamber 102 and a cathode 110 at another end of the gas chamber 102. In an example, a distance between the anode 108 and the cathode 110 may be adjustable. In an example, the anode 108 is a filament. For example, the anode 108 may be made of stainless steel, tungsten, copper, tantalum, lanthanum hexaboride, carbon, and the like. In one embodiment, the cathode 110 is made of a boron-rich material. In an example, the cathode 110 has a length in a range of 1 cm to 20 cm. In another example, the cathode 110 has a length in a range of 3 cm to 10 cm. For example, the cathode 110 may be coated with an electron-emitting material. To this end, a reactant of the cathode is boron or (¹¹B). Examples of such boron-rich material may include, but are not limited to, lanthanum hexaboride (LaB₆), cerium hexaboride (CeB₆), lithium boride (LiB₂), pure boron (B), and boron nitride (BN). Pursuant to embodiments of the present disclosure, the cathode 110 may be made of lanthanum hexaboride or LaB₆ slab and may emit electrons when heated.

In one embodiment, the input power supply 106 imposes an electric potential across the anode 108 and the cathode 110. Pursuant to examples of the present disclosure, the gas chamber 102 is imposed with a voltage across the anode 108 and the cathode 110. In an example, the gas chamber 102 is energized by externally applying the voltage in a range of 10 Volts to 1000 Volts.

In an example, the gas chamber 102 is insulated using an insulation material. For example, the insulation material is made of boron nitride (BN) or any other suitable materials which is electrically non-conductive.

The gas chamber 102 is filled with the neutral gas 104. For example, the neutral gas 104 may comprise at least molecular hydrogen (H₂) gas. In other example, the neutral gas 104 may be a mixture of H₂ gas along with other gasses. In an example, the neutral gas 104 may comprise the H₂ gas and Argon (Ar) gas. For example, a density of the neutral gas 104 (also referred to as, H₂ gas 104, hereinafter) may be in a range of 1×10²⁰ to 1×10²⁵ m⁻³.

Pursuant to present disclosure, the cathode 110 may be a LaB₆ slab. In an example, the cathode 110 is grounded and thus has a potential of 0 V. Moreover, the anode 108 is at a given potential, for example, ϕₐ is in a range of 1 V to 1000 V. The LaB₆ cathode 110 is placed in the gas chamber 102 filled with hydrogen gas. In an example, a gas pressure of the hydrogen gas is maintained at about 1-100 Torr, for example using a pressure gauge. To this end, current inside the gas chamber 102 flows from the anode 108 to the LaB₆ cathode 110.

Further, the applied voltage may heat the LaB₆ cathode 110 and ionize the neutral gas 104. The heated LaB₆ cathode 110 may emit electrons. Subsequently, a conducting channel 112 with a small diameter may be built up between the charged cathode or the LaB₆ cathode 110 and the anode 108. In an example, a diameter of the conducting channel 112 may be in a range of 0.01 millimeters to 1 millimeter (mm).

In accordance with an embodiment, the conducting channel 112 is established between the cathode 110 and the anode 108 for individual protons and electrons configured to overcome the collisions with the hydrogen gas 104 and accelerated by an electric potential to result in a p-¹¹B fusion reaction.

In one embodiment, the input power supply 106 imposes an electric potential, for example, in a range of 1 V to 1000 V, across the anode 108 and the cathode 110.

Continuing further, the externally imposed electric potential across the cathode 110 and the anode 108 of the gas chamber 102 causes ionization of the neutral gas 104. In other words, the imposed electric potential leads to the formation of a fully or partially ionized hydrogen gas 104. In an example, the partially or fully ionized hydrogen gas may include electrons and ions. For example, the ions may include at least one of positively charged ions, such as H⁺ ions, or negatively charged ions, such as H⁻ ions. Pursuant to present disclosure, the positively charged H⁺ ions correspond to protons of the plasma. For example, the term “H⁺ ions” and protons may be used interchangeably. In certain cases, the fully or partially ionized plasma may also include other type of positively charged ions, such as Ar⁺ ions, when the neutral gas 104 is composed of hydrogen gas and Argon gas. In particular, a plurality of protons and other positive ions, Ar⁺ ions, (collectively referred to as positive charges), as well as electrons and negative ions, H⁻ ions, (collectively referred to as, negative charges) are produced in the gas chamber 102 during the ionization of the neutral gas 104.

The electric potential heats the cathode 110 and causes emission of a set of thermionically emitted electrons by the cathode 110. The set of thermionically emitted electrons forms an electron layer 114 having a negative charge density. For example, the electron layer 114 may be formed near an outer surface of the cathode 110, i.e., outside at a distance from the cathode 110. In an example, the set of thermionically emitted electrons forms the electron layer 114 of negative charge density locally within the gas chamber 102 near the cathode 110.

In one embodiment, the electron layer 114 together with the imposed electric potential across the gas chamber 102 leads to the formation of a large electrostatic potential with a dip. For example, the electrostatic potential at the peak and the dip may be in a range of 1 kV to 100 kV. In this regard, the initial potential dip (referred to as a first potential dip, hereinafter) is formed by the presence of the electron layer 114, wherein the electron layer 114 is formed due to the set of thermionically emitted electrons by the heated cathode 110.

To this end, the positive charges and the negative charges may be accelerated with different velocities leading to an electron-ion two-stream instability, due to the first potential dip. In particular, the negative charges are accelerated away from the electron layer 114 with a first velocity, and the positive charges are accelerated towards the electron layer 114 with a second velocity. In the region between the electron layer 114 and the anode 108, electron-ion two-stream instability takes place. Further, pursuant to present disclosure, certain amount of the positive charges and the negative charges from the ionized neutral gas 104 are accelerated by electric fields formed due to the electron layer 114. For example, an electric field may be formed between a region associated with the first potential dip and the cathode 110. In an example, some amount of the negative charges or electrons from the ionized neutral gas 104 may be accelerated by the electric field between the region associated with the first potential dip and the cathode 110, such that the negative charges are accelerated towards the cathode 110. It may be noted that the region associated with the first potential dip, or the region of the electron layer 114, lies between the anode 108 and the cathode 110. Such acceleration of the positive charges and the negative charges in different directions and with different velocities may lead to the electron-ion two-stream instability and an electrostatic potential profile with a plurality of dips and a plurality of peaks.

In this manner, the ionized neutral gas 104, specifically negative charges of the ionized neutral gas 104, may be accelerated by the first potential dip and the electric potential of the electron layer 114 to bombard the cathode 110 to emit another plurality of electrons (referred to as a set of secondary electrons, hereinafter). The set of secondary electrons may further enhance the strength of the electron layer 114. For example, the set of secondary electrons may increase negative charge density of the electron layer 114. In an embodiment, the set of secondary emitted electrons lead to the formation of the enhanced electron layer 114 near the cathode 110 that causes formation of the electrostatic potential profile within the conducting channel 112.

To this end, due to the electron-ion two-stream instability, an electrostatic potential profile with a plurality of dips and a plurality of peaks is formed within the conducting channel 112.

In an example, individual electrons and positive and negative ions (collectively referred to as ions, hereinafter) from the ionized neutral gas 104 may overcome the collisions between the electrons and ions from the ionized neutral gas 104 and the molecules of dense non-ionized hydrogen gas 104. The electrons and ions from the ionized neutral gas 104 may be accelerated to high velocity by an electric potential, within the conducting channel 112. In an example, the protons and electrons are accelerated for the p-¹¹B fusion by the electric potential in the gas chamber 102 due to the electron layer 114, with relatively dense hydrogen gas density in the gas chamber 104. For example, the protons of the ionized neutral gas 104 may bombard into the cathode 110. The bombardment of the accelerated protons into the cathode 110 enables to perform a controlled fusion reaction and produce energy. In particular, the protons may bombard in to the LaB₆ cathode 110, wherein the cathode 110 provides boron as the fuel for the fusion reaction. In this manner, p-¹¹B fusion reaction is performed. In an example, the kinetic energy of each charged particle, such as the proton or H⁺ ion, bombarding onto the cathode 110 is in a range of 1 keV to 100 keV.

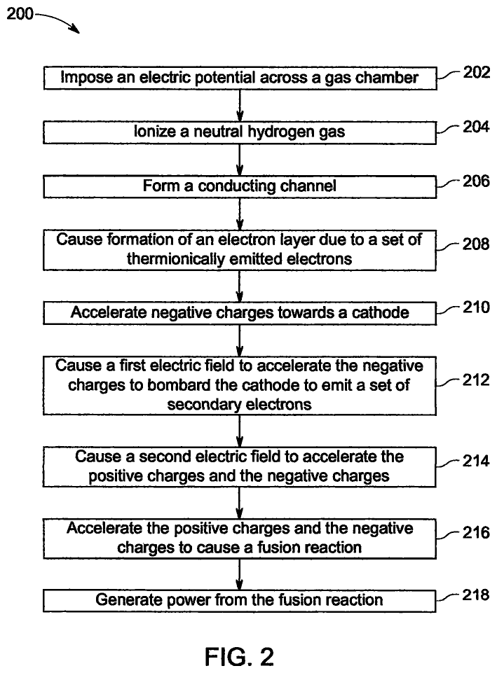

FIG. 2 shows a flowchart 200 depicting steps of a method for performing a controlled fusion reaction, according to some embodiments of the present disclosure. The controlled fusion reaction is performed between proton and boron in a gas chamber, such as the gas chamber 102. As described above, the gas chamber 102 includes the anode 108, the cathode or LaB₆ cathode 110 and the neutral gas 104 dispersed within the gas chamber 102. In an example, the neutral gas 104 comprises at least molecular hydrogen (H₂) gas. Further, the gas chamber 102 is connected to the input power supply 106. For example, the input power supply may impose electric potential on the gas chamber 102. The cathode 110 is grounded.

At 202, an electric potential is imposed across the gas chamber 102 filled with the neutral hydrogen gas 104. To this end, an initial discharge current due to the electric potential imposed externally on the gas chamber 102 causes ionization of the neutral hydrogen gas 104 and heats the LaB₆ cathode 110.

At step 204 the neutral hydrogen gas 104 is partially ionized due to the electric potential to produce electrons, and ions. In an example, the partially ionized neutral gas 104 generates plasma with positively charged or positive H⁺ ions, negatively charged or negative H⁻ ions and electrons. In accordance with other examples, ionization of the neutral hydrogen gas 104 may form the plasma comprising of H⁺ ions, H⁻ ions, and electrons (e⁻).

At 206, a conducting channel 112 is formed, due to the ionization of the neutral gas 104. The conducting channel 112 is formed between the anode 108 and the cathode 110.

At 208, a set of thermionically emitted electrons are emitted by the LaB₆ cathode 110, due to the heating of the LaB₆ cathode 110. In particular, the set of thermionically emitted electrons may be emitted from a surface of the LaB₆ cathode 110 into a region outside the cathode 110 and at a distance from the cathode 110. Within the region outside the cathode 110, where the set of thermionically emitted electrons accumulate, formation of the electron layer 114 may occur. The electron layer 114 may have a negative charge density locally outside the surface of the cathode 110. The set of thermionically emitted electrons emitted from the surface of the cathode 110 into the region may form a first potential dip within the region. Subsequently, the region of the electron layer 114 may also indicate the region associated with the first potential dip.

At 210, the electron layer 114 together with the imposed electric potential across the gas chamber 102 causes the electrons and the negative ions (or negative charges) from the plasma (ionized neutral gas 104) to accelerate towards the cathode 110. The negative charges bombard into the cathode 110.

At 212, a first electric field (E₁) between the region of the first potential dip and the cathode 110 causes acceleration of negative charges to bombard the LaB₆ cathode 110 to emit a set of secondary electrons. The first electric field may be directed from the cathode 110 towards a center of the electron layer 114 corresponding to the first potential dip. Further, the emitted set of secondary electrons move into the electron layer 114 region to enhance the strength of the electron layer 114.

At 214, a second electric field (E₂) between the anode 108 and the electron layer 114 is formed. The second electric field causes acceleration of the negative charges towards the anode 108 and acceleration of the positive charges towards the electron layer 114. Such acceleration of the positive charges and the negative charges due to the second electric field leads to electron-ion two-stream instability.

Due to the electron-ion two-stream instability, an electrostatic potential profile having a plurality of potential peaks and a plurality of potential dips is formed within the conducting channel 112 in the gas chamber 102. To this end, the negative charges are accelerated towards the cathode 110, at each of the plurality of dips, to cause the cathode 110 to emit the set of secondary electrons and enhance the strength of the negative charge density of the electron layer 114.

At 216, the positive charges and the negative charges are accelerated to cause fusion reaction. In particular, at the plurality of dips of the electrostatic potential profile, the negative charges, such as the electrons and/or H⁻ ions are accelerated towards the LaB₆ cathode 110. Such acceleration of the negative charges cause emission of electrons from the LaB₆ cathode 110 causing a potential dip that further causes the electron-ion two stream instability within the gas chamber 102, as described in detail above. Further, at the plurality of peaks of the electrostatic potential profile, the positive charges, specifically, the protons are accelerated towards the LaB₆ cathode 110. Such acceleration of the protons towards the LaB₆ cathode 110 may cause the protons to bombard the LaB₆ cathode 110 with high velocity and kinetic energy, thereby causing a fusion reaction between the proton and boron of the LaB₆ cathode 110.

At 218, a power is generated from the fusion reaction. In an example, an energy in a range of 1 keV-100 keV may be achieved from the acceleration of the proton. Further, an average energy of about 3 MeV may be generated for each ⁴He ion formed from the fusion of a proton and a boron atom. Further, the bombardment of the protons on the LaB₆ cathode 110 may produce more sets of secondary electrons to enhance the electron layer 114 and the associated potential dip.

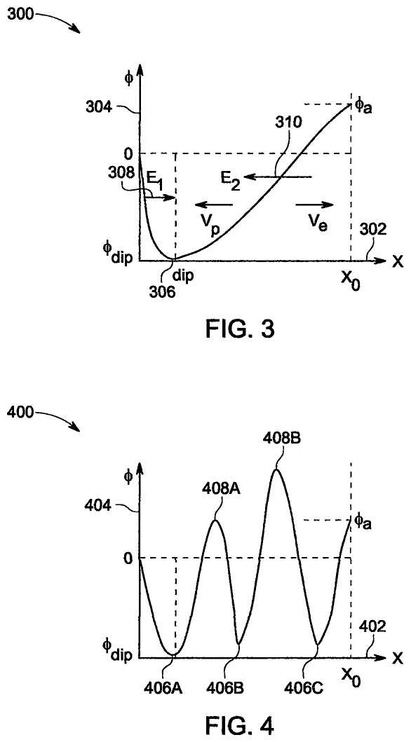

FIG. 3 illustrates a graph 300 depicting the flow of electron at a first potential dip, in accordance with some embodiments. The graph 300 represents x₀ at a horizontal axis 302, wherein the x₀ represents length between the cathode 110 and the anode 108 within the gas chamber 102. Further, the graph 300 represents φ at a vertical axis 304, wherein the φ represents electric potential across the gas chamber 102. As shown, at the dip 306, the electric potential is substantially low, indicated by φ_{dip}. Further the dip 306 is formed towards left-hand side of the gas chamber 102, wherein the cathode 110 is positioned at the left-hand side of the gas chamber 102. To this end, the dip 306 is formed near the cathode 110, for example, due to the formation of the electron layer 114 due to the thermionically emission of electrons.

As described above, an externally imposed electric potential ϕₐ leads to the formation of partially ionized hydrogen gas. As the LaB₆ cathode 110 is heated, the set of thermionically emitted electrons are emitted from a surface of the LaB₆ cathode 110 to form the electron layer 114 having negative charge density. The net negative charge density leads to a large electrostatic potential well near the surface of the LaB₆ cathode 110 due to the potential dip 306, such as the first potential dip, φ_{dip}.

Further, a first electric field (E₁) 308 is formed near the cathode 110. For example, the E₁ 308 is directed from the cathode 110 towards a center of the electron layer 114. The E₁ 308 may accelerate electrons and/or negatively charged ions, i.e., negative charges from the ionized neutral gas 104 or plasma to bombard the LaB₆ cathode 110. This may cause the LaB₆ cathode 110 to emit a set of secondary electrons. The set of secondary electrons may enhance the strength of the electron layer 114, forming a positive feedback loop. For example, the set of secondary electrons may enhance the strength of the potential dip 306, φ_{dip}. As shown in FIG. 3, the first electric field E₁ 308 causes acceleration of the negative charges towards a region associated with the first potential dip (φ_{dip}) to bombard the cathode 110.

Moreover, a second electric field (E₂) 310 is also formed within the gas chamber 102. The second electric field E₂ 310 causes acceleration of the negative charges away from the region associated with the first potential dip, i.e., towards the anode 108 and acceleration of the positive charges towards the region associated with the first potential dip and towards the cathode 110.

In a region slightly away from the LaB₆ cathode 110 and the electron layer 114, an electric potential φ increases toward the anode 108 (right-hand side). Due to acceleration of positive charges and negative charges with different flow velocities (Vₚ and Vₑ, respectively) and in opposite direction, electron-ion two-stream instability may occur in the gas chamber 102. This electron-ion two-stream instability excites strong waves, leading to forming of an electrostatic potential profile having the plurality of potential dips and the plurality of potential peaks.

As shown, at the dip 306, the electric potential is substantially low, indicated by φ_{dip}. Further the dip 306 is formed towards left-hand side of the gas chamber 102, wherein the cathode 110 is positioned at the left-hand side of the gas chamber 102. To this end, the dip 306 is formed near the cathode 110, for example, due to the formation of the electron layer 114 due to thermionic emission of the set of thermionically emitted electrons.

FIG. 4 illustrates a graph 400 depicting an electrostatic potential profile, in accordance with some embodiments. The graph 400 represents x₀ at a horizontal axis 402, wherein the x₀ represents distance between the cathode 110 and the anode 108 within the gas chamber 102. Further, the graph 400 represents φ at a vertical axis 404, wherein the φ represents electric potential across the gas chamber 102.

The electrostatic potential profile includes a plurality of dips, depicted as dips 406A, 406B and 406C. The electrostatic potential profile also includes a plurality of peaks, depicted as peaks 408A and 408B. In particular, the electrostatic potential profile is initialized with a dip, such as the first potential dip. From the peak, positive charges may bombard on the LaB₆ cathode 110 to carry out the proton-Boron (p-¹¹B) fusion reaction.

In particular, the negative charges from the ionized neutral gas 104 are accelerated towards the cathode 110, at some of the plurality of dips 406A, 406B and 406C. The dips, at which the negative charges are accelerated towards the cathode 110, may cause the cathode 110 to emit the set of secondary electrons. For example, the dips are formed near the cathode 110 due to the electron layer 114 formed outside the cathode 110.

Further, the positive charges from the ionized neutral gas 104 are accelerated towards the cathode 110, at some of the plurality of peaks 408A and 408B. The peaks 408, at which the positive charges are accelerated towards the cathode 110, cause positive charges to bombard into the cathode 110. For example, the bombardment of the accelerated protons and the positive ions (such as Ar⁺ ions) (i.e., the positive charges) into the cathode 110 causes a controlled fusion reaction and generation of a power from the fusion reaction.

To ascertain the output of the proton-boron fusion reaction, certain outcomes of the fusion reaction performed in the gas chamber 102 may be determined. Such outcomes may include, for example, a proton-boron fusion cross section, a transportation of protons and electrons in the relatively dense neutral hydrogen gas, and an estimation of a power gain. As may be understood, the accelerated protons may cause the proton-Boron fusion. To this end, calculation of output for the p-¹¹B fusion may be performed based on a simulation of the p-¹¹B fusion reaction.

In an example, the fusion cross section is a function of a center-of-mass energy (E_{cm}) for the proton-boron (p-11B) fusion reaction. In particular, the effect of the center-of-mass energy is particularly significant in low-energy region. For example, when the center-of-mass energy is varied from about 1 keV to about 40 keV, the fusion cross section is increased by about 50 orders of magnitude.

The formation of the electron layer 114 leads to a strong electric field, which accelerates protons. During the acceleration, proton-neutral collisions occur, i.e., collision of proton with atoms of the neutral hydrogen gas 104. To this end, a fraction of the protons cannot be accelerated to the peak energy as they reach the LaB₆ cathode 110 target. Further, the solid boron compound is also used as a reactant for the p-¹¹B fusion process. In this regard, based on the proton-neutral collision effect, an acceleration and collision process to obtain the energy distributions of protons reaching the LaB₆ cathode target 110 is identified.

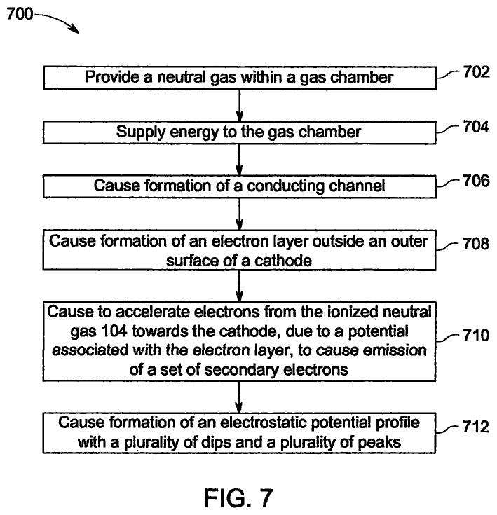

A series of calculations is conducted. The electric potential difference is assumed to be 50 kV, and a length of an acceleration path is assumed to be 1 mm or 10 mm in the calculations. High-density neutrals gas (molecular hydrogen) is uniformly filled in a space. The proton transportation through the high-density molecular hydrogen with a strong electric field is simulated by Geant4 (Geometry and Tracking software), which is a Monte Carlo toolkit used for the simulation of the transportation of particles through matter. As may be understood, a proton with an initial energy ∈ᵢₙ is injected into the hydrogen gas and undergoes acceleration and collisions, and its final energy ∈_{f} is recorded as it reaches the other side. The simulation result of the proton transportation through the high-density molecular hydrogen is described in detail with the following FIG. 7. The manner in which the proton transportation is simulated in FIG. 7 is only exemplary and should not be construed as a limitation. In other embodiments of the present disclosure, the proton transportation may be simulated under different conditions, for example, with different values for the electric potential difference, the length for the acceleration path, and so forth.

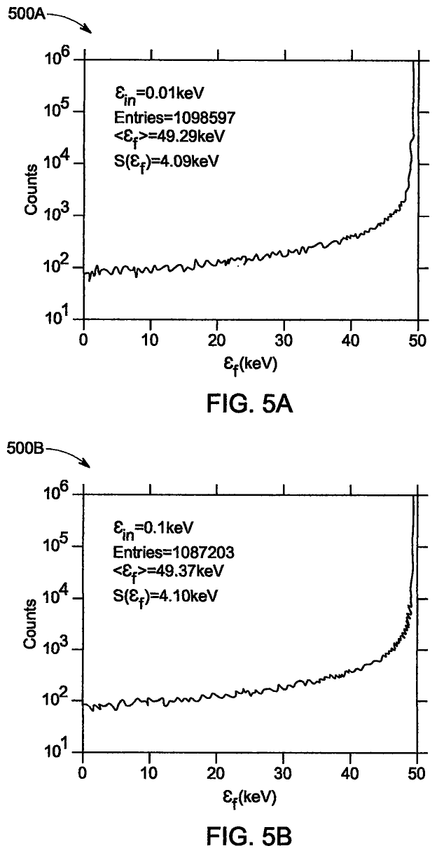

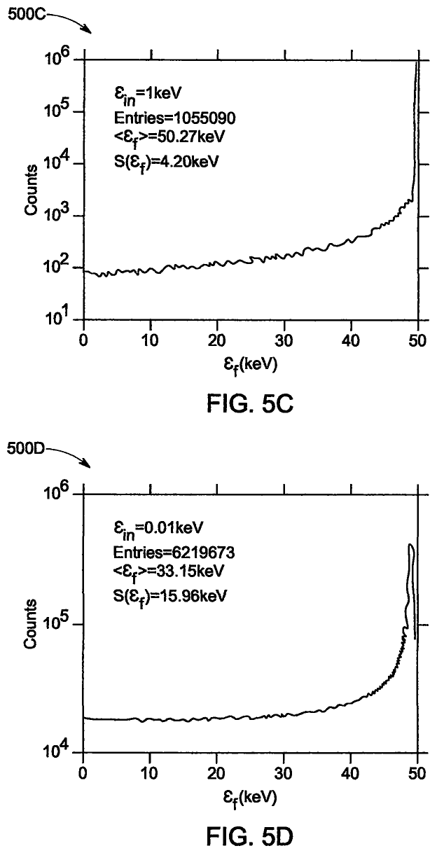

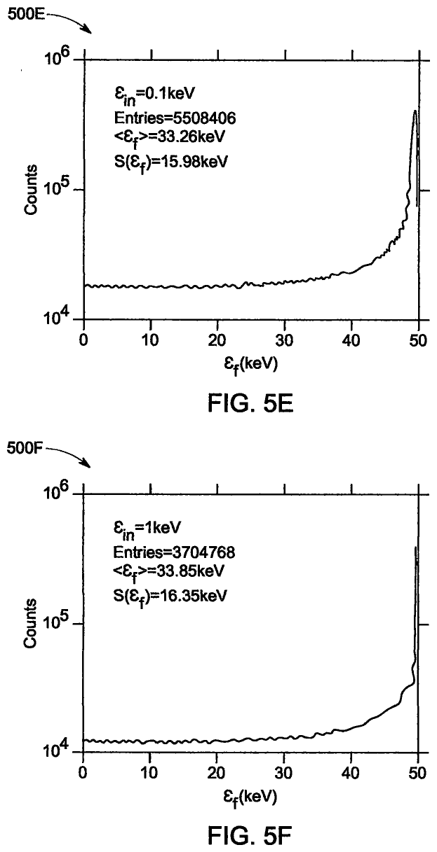

FIGS. 5A-5F illustrates example graphical representation of an energy distribution of protons colliding onto the cathode 110 target after travelling through the acceleration path in the calculations, according to some embodiments of the present disclosure. The graphs 500A, 500B, 500C, 500D, 500E, and 500F of the FIGS. 5A, 5B, 5C, 5D, 5E, and 5F, respectively, represent a corresponding final energy ∈_{f} at a horizontal axis, wherein the ∈_{f} represents final energy of the accelerated protons as they collide onto the cathode 110 target after travelling through the acceleration path in the calculations. Further, the graphs 500A, 500B, 500C, 500D, 500E, and 500F represents counts at a vertical axis, wherein the counts represents a number of protons colliding onto the target after travelling through the acceleration path in the calculations.

To this end, in FIGS. 5A-5F show an energy distribution of outgoing protons for different incident energies ∈ᵢₙ=0.01, 0.1, and 1 keV with acceleration path lengths of 1 mm and 10 mm. The density of neutral hydrogen gas is assumed to be 3.3×10²³ m⁻³ and the temperature is assumed to be in a range of 1000 K to 5000 K in the calculations. A final energy [symbol] ∈_{f} [symbol] and standard deviation S [symbol] ∈_{f} [symbol] of the accelerated protons are determined. From FIG. 5A-5F, it may be concluded that the energy loss from collisions along the acceleration path is insignificant.

The multi-fluid simulation is studied along an x-axis to study the formation of the electrostatic potential profile in the conducting channel 112 in the gas chamber 102. The electrostatic potential profile has a plurality of potential peaks and a plurality of potential dips. To this end, the protons or the H⁺ ions from the plasma are accelerated through the conducting channel 112 at the plurality of peaks to cause the p-¹¹B fusion reaction.

In an example, the system length x₀ or the length corresponding to the conducting channel 112 within the gas chamber 102 may be in a range of 1 mm to 10 mm. Pursuant to the present example, the system length x₀ is given by x₀=2 mm. The initial plasma temperature (T) is assumed to be about 4000 K. Since the ionization ratio within the gas chamber 102 is very small, the neutral gas density nₙ is assumed to be constant in the simulation.

Since the neutral fluid is affected mainly through the collisional effect, the proton-neutral collision frequency vₚₙ is the order of 10⁹ Hertz (Hz). Further, the proton to neutral mass density ratio is 4×10⁻⁴. In an example, when the plasma collides with the neutral fluid, the plasma may ionize the neutral fluid.

A relation mₚnₚvₚₙ=mₙnₙvₙₚ gives that the neutral to proton collision frequency is vₙₚ=mₚnₚvₚₙ/mₙnₙ. For example, the neutral-proton collision frequency is in the order of 10⁵-10⁶ Hz. As a result, in a time scale of nanoseconds, the neutral fluid can be assumed to be immobile.

The incident electrons collide into the LaB₆ cathode 110 boundary and are bounced back due to the bounded boundary. Thermionically emitted electrons and secondary electrons are considered in the simulation system. Due to the increase of boundary electron density or the increased strength of the electron layer 114 due to the set of secondary electrons, an increase of electric potential at the electron layer 114 and electric field is observed. The electric field leads to further heating and ionization. As a result, the ion density as well as ionization ratio in the neutral gas 104 increases. In the simulation, the plasma temperature is assumed to increase from, for example, 4000 K to about 5000 K. The plasma density also increases with the plasma temperature from, for example, 10⁻⁶ n₀ to about 10⁻⁴ n₀. In the gas chamber 102, electron-ion two-stream instability may occur. As a result, an electrostatic potential profile of plurality of peaks and plurality of dips is formed within the conducting channel 112. In this manner, the plurality of potential peaks may be achieved where the protons of the ionized neutral gas 104 or plasma are accelerated to bombard onto the LaB₆ cathode 110 to cause fusion reactions.

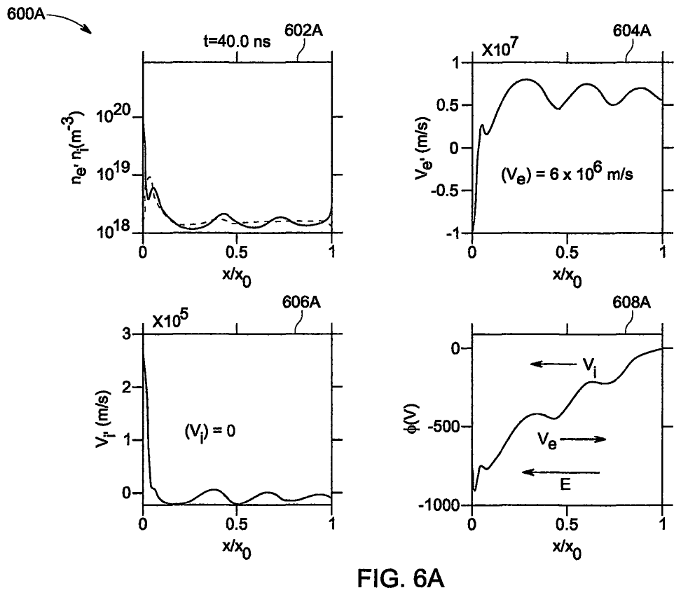

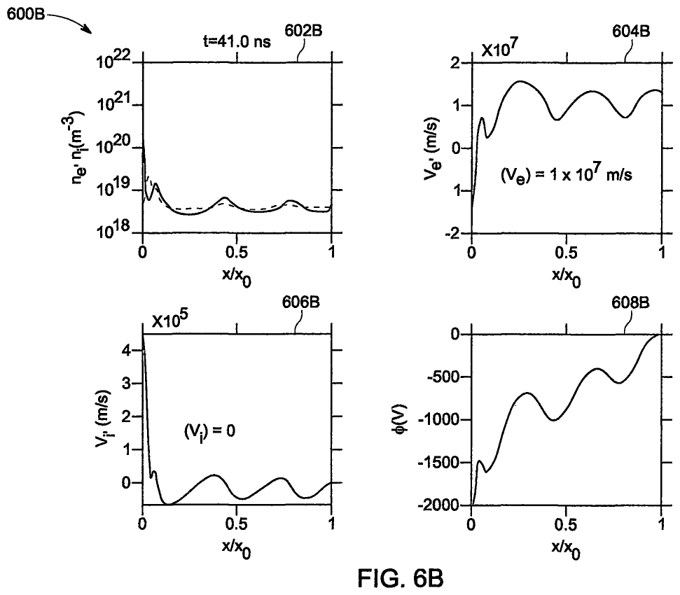

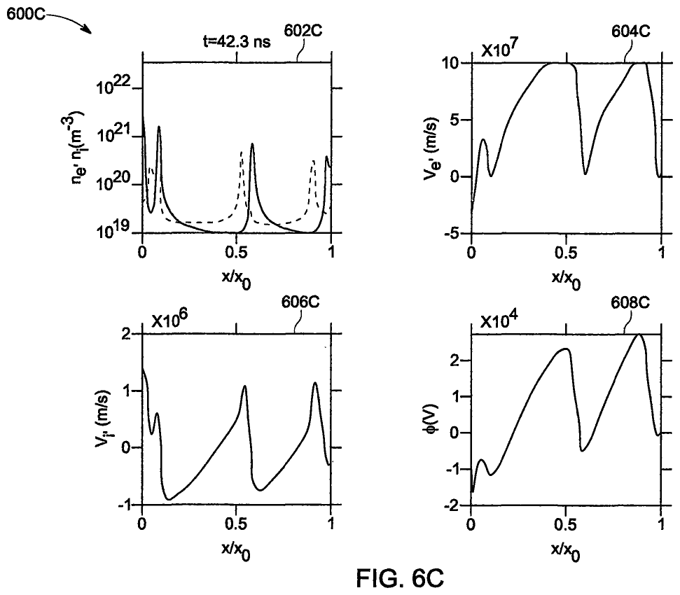

FIGS. 6A-6C illustrate simulation results corresponding to potential peaks and potential dips, according to some embodiments of the present disclosure. In FIGS. 600A, 600B and 600C, the simulation results are shown at t=40.0 nanoseconds (ns), t=41.0 ns and t=42.3 ns.

During the operation in the simulation, the boundary electron density or negative charge density outside the LaB₆ cathode 110 due to the enhanced electron layer increases approximately to 10²³ m⁻³. The increase in the boundary electron density with time is due to continuous electron emission from LaB₆ cathode 110, for example, due to emission of the thermionically emitted electrons and the set of secondary electrons. It may be noted that although the present disclosure only describes emission of the set of thermionically emitted electrons and the set of secondary electrons from the LaB₆ cathode 110, however, this should not be construed as a limitation. To this end, the LaB₆ cathode 110 may emit electrons continuously. Moreover, electrons forming the set of thermionically emitted electrons and electrons forming the set of secondary electrons, or other set of electrons emitted from the LaB₆ cathode 110, are not mutually exclusive. In an example, certain electrons emitted from the LaB₆ cathode 110 may be incident back to the LaB₆ cathode 110 at the plurality of dips and the LaB₆ cathode 110 may further re-emit electrons.

Around the electron layer 114, an electric potential dip is formed due to the high-density electron layer 114. For example, due to enhanced strength of the electron layer 114, the negative charge density is, for example, in a range of 10 to 100 kilovolts (kV), that may be indicated by the electrostatic potential profile.

In an example, the set of thermionically emitted electrons from thermionic emission from the LaB₆ cathode 110 and the set of secondary electrons lead to the formation of the electron layer 114 near the cathode 110, for example, at x≈0. Due to the electron layer 114, an electric potential ϕ has a sharp decrease from ϕ(x=0) to ϕ_{dip}<0. The electric potential ϕ then increases slowly towards the anode 108, for example, ϕ(x=x₀)=ϕₐ V at the anode 108. The electric field in a region from the anode 108 towards the electron layer 114 and may be negative (Eₓ<0). The negative electric field in the gas chamber 102 may accelerate electrons at high speed Uₑ≈2.4×10⁷ m/s towards the anode 108, while positive charges are accelerated towards the cathode 110 with small velocity due to large mass of the positive charges. The positive charges and the negative charges are accelerated in opposite directions with different velocities, which leads to the electron-ion two-stream instability.

In the electrostatic potential profile, large amplitude of waves is formed due to this instability. For example, the amplitude of the waves may be in tens of kilovolts. The number density and velocity profiles of the positive charges and the negative charges also show such pattern of large amplitude of electrostatic waves.

The FIGS. 6A, 6B and 6C illustrate plot 602A, 602B and 602C, respectively. The plots 602A, 602B and 602C show change in electron density (nₑ) and/or ion density (nᵢ) over system length x₀, at different times, for example, at 40.0 ns, 41.0 ns and 42.3 ns, respectively. Further, FIGS. 6A, 6B and 6C illustrate plot 604A, 604B and 604C, respectively, illustrating change in flow velocity of electrons (Vₑ) over the system length (x₀), at time, for example, at 40.0 ns, 41.0 ns and 42.3 ns, respectively. FIGS. 6A, 6B and 6C also illustrate plot 606A, 606B and 606C, respectively, illustrating change in flow velocity of protons (Vᵢ) over the system length (x₀), at time, for example, at 40.0 ns, 41.0 ns and 42.3 ns, respectively. FIGS. 10A, 10B and 10C also illustrate a plot 608A, 608B and 608C, respectively, illustrating change in electric potential (ϕ) over the system length (x₀), at different times, for example, at 40.0 ns, 41.0 ns and 42.3 ns, respectively.

From the plots 608A, 608B and 608C, an electric potential at a peak is observed to reach about 30 kV, whereas electric potential at a dip is observed to reach about −10 kV.

The formation of negative electric potential dips may accelerate electrons towards the LaB₆ cathode 110, and formation of positive electric potential peaks may accelerate protons towards the LaB₆ cathode 110. Bombardment of the LaB₆ cathode 110 by the protons leads to p-¹¹B fusion. The fusion emits ˜3 MeV helium (He) in average, which may further generate protons through collisions. These protons bombard the LaB₆ cathode 110 and generate more helium whereby ensure the continuity of fusion reactions, thereby forming a positive feedback loop.

FIG. 7 illustrates an example flowchart depicting steps of a method for performing a controlled fusion reaction in the gas chamber 102, according to some example embodiments.

At 702, a neutral gas 104 is distributed within the gas chamber 102. The gas chamber 102 comprises the anode 108, the cathode 110 and the neutral gas 104 dispersed within the gas chamber 102. In an example, the cathode 110 comprises a boron rich material, such as lanthanum hexaboride (LaB₆), cerium hexaboride (CeB₆), lithium boride, pure boron, boron nitride (BN), or a combination thereof. The cathode 110 provides boron for the controlled fusion reaction. In an example, the neutral gas 104 comprises at least molecular hydrogen (H₂) gas. For example, a density of the neutral gas 104 is in a range of 1×10²⁰ m⁻³ to 1×10²⁵ m⁻³.

At 704, energy is supplied to the gas chamber 102. In particular, an external electric potential is applied to the anode 108 and the cathode 110 in the gas chamber 102. The external electric potential initiates heating of the cathode 110, and ionization of the neutral gas 104 into protons and electrons. In an example, an initial discharge current due to the external electric potential may heat the cathode 110 and ionize the neutral gas 104. In some cases, the neutral gas 104 may be weakly ionized. In such a case, the neutral gas 104 may be ionized into the protons or the positive ions (H⁺ ions), the electrons, and the negative ions (H⁻ ions). In an example, the gas chamber 102 is energized by externally applying a voltage in a range of 10 V to 1000 V.

In certain cases, a heating source may be applied to the gas chamber 102 to perform the heating of the cathode 110 and the ionization of the neutral gas 104 into the protons and the electrons. For example, the heating source may be a superconducting magnet source, a permanent magnet source, an electromagnet source, a radiofrequency (RF) source, a microwave source, an electric field source, an electrode source, a laser source, an ion gun source, or a combination thereof.

At 706, the conducting channel 112 is formed between the anode 108 and the cathode 110. The conducting channel 112 is formed due to the ionization of the neutral gas 104. In an example, a diameter of the conducting channel 112 is in a range of 0.01 mm to 1 mm.

At 708, the electron layer 114 is formed outside an outer surface of the cathode 110. The electron layer 114 is formed due to emission of a set of thermionically emitted electrons by the heated cathode 110. In an example, the electron layer 114 causes formation of a first potential dip, due to the set of thermionically emitted electrons emitted by the heated cathode 110. For example, the set of thermionically emitted electrons may be emitted from the surface of the cathode 110 into a region associated with the first potential dip. Subsequently, the electron layer 114 having a negative charge density is formed locally outside the surface of the cathode 110.

At 710, the electrons from the ionized neutral gas 104 are accelerated towards the cathode 110, due to a potential associated with the electron layer 114. The electrons accelerated towards the cathode 110 may bombard the cathode 110 to cause the heated cathode 110 to emit a set of secondary electrons. The set of secondary electrons may also be deposited outside the cathode 110 within the electron layer 114. As a result, the set of secondary electrons enhances strength of the electron layer 114.

In particular, the electrons are accelerated between a region associated with the first potential dip and the cathode 110 to bombard the cathode 110. The region lies between the anode 108 and the cathode 110. The bombardment of the accelerated electrons at the cathode 110 causes emission of the set of secondary electrons. Further, the electron layer 114 is strengthened at the first potential dip, due to the set of secondary electrons emitted by the cathode 110.

In an example, the region of the first potential dip outside the cathode 110 of the gas chamber 102 is formed due to the enhanced strength of the electron layer 114. The region of the first potential dip has a minimum potential value at a center of the electron layer 114. Moreover, a first electric field is directed from the cathode 110 towards the center of the electron layer 114, and a second electric field is directed from the anode 108 towards the center of the electron layer 114.

At 712, an electrostatic potential profile is formed within the conducting channel 112, due to an electron-ion two-stream instability. The electrostatic potential profile may comprise a plurality of dips and a plurality of peaks, In an example, the formation of the electrostatic potential profile within the conducting channel 112 is associated with the formation of the enhanced electron layer 114 and the strengthened first potential dip.

For example, negative charges or electrons and positive charges or protons are accelerated due to the enhanced strength of the electron layer 114. In an example, the negative charges may include the electrons and the negative ions (for example, H⁻ ions), and the positive charges may include the protons (for example, H⁺ ions) and the positive ions (for example, Ar⁺ ions). Due to the strengthened first potential dip, the negative charges may be accelerated from the cathode 110 towards the anode 108 and the positive charges are accelerated from the anode 108 towards the cathode 110. To this end, the positive charges and the negative charges are accelerated in opposite directions and have a velocity difference. The velocity difference between the positive charges and the negative charges and opposite direction of flow of the positive charges and the negative charges may cause the electron-ion two-stream instability within the gas chamber 102.

In this regard, the negative charges or electrons are accelerated towards the cathode 110, at each of the plurality of dips, to cause the cathode 110 to emit the set of secondary electrons. Further, the positive charges or protons are accelerated towards the cathode 110 at each of the plurality of peaks, to bombard into the cathode 110. The bombardment of the accelerated protons and the positive ions (H⁺ ions) into the cathode 110 enables the controlled fusion reaction and causes generation of power. In an example, the protons and the positive ions are accelerated to bombard the cathode 110 with a high kinetic energy. For example, the kinetic energy of each charged particle (proton or positive ion) bombarding into the cathode 110 is in a range of 1 keV to 100 keV.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method to perform a controlled fusion reaction, the method comprising:
providing a neutral gas within a gas chamber, the gas chamber comprising an anode and a cathode and neutral gas dispersed within the gas chamber;
supplying energy to the gas chamber, wherein the supplying of the energy initiates at least: heating of the cathode, and ionization of the neutral gas into protons and electrons;
causing formation of a conducting channel, due to the ionized neutral gas;
causing formation of an electron layer outside an outer surface of the cathode, based on a set of thermionically emitted electrons by the heated cathode;
causing acceleration of the electrons from the ionized neutral gas towards the cathode, due to a potential associated with the electron layer, to cause the heated cathode to emit a set of secondary electrons wherein the emitted set of secondary electrons enhances a strength of the electron layer; and
causing formation of an electrostatic potential profile within the conducting channel due to an electron-ion two-stream instability, the electrostatic potential profile comprising a plurality of dips and a plurality of peaks, wherein the protons from the ionized neutral gas are accelerated towards the cathode at the plurality of potential peaks and bombardment of the accelerated protons into the cathode enables the controlled fusion reaction.

2. The method of claim 1, wherein the method comprises:
causing an initial discharge current to heat the cathode and ionize the neutral gas; and
causing formation of a first potential dip of the plurality of potential dips, due to the set of thermionically emitted electrons by the heated cathode.

3. The method of claim 2, wherein the method comprises:
causing acceleration of the electrons between a region associated with the first potential dip and the cathode to bombard the cathode, wherein the region lies between the anode and the cathode;
causing emission of the set of secondary electrons, due to the bombardment of the accelerated electrons at the cathode;
causing strengthening of the electron layer, at the first potential dip of the plurality of potential dips, due to the set of secondary electrons emitted by the cathode; and
causing formation of the electrostatic potential profile within the conducting channel, due to the strengthened electron layer, the conducting channel with the electrostatic potential profile being associated with the formation of the enhanced electron layer and the strengthened first potential dip.

4. The method of claim 3, wherein the method further comprises:
causing emission of the set of thermionically emitted electrons, due to the heating of the cathode, the set of thermionically emitted electrons being emitted from the surface of the cathode into the region associated with the first potential dip; and
causing formation of the electron layer having a negative charge density locally outside the surface of the cathode.

5. The method of claim 1, wherein the method comprises:
supplying energy to the gas chamber to partially ionize the neutral gas to generate a plasma, the plasma comprising the protons, the electrons, positive ions, and negative ions, and
causing the electrons and the negative ions to accelerate towards the cathode to cause the bombarded cathode to emit the set of secondary electrons.

6. The method of claim 5, wherein the method further comprises:
causing formation of a region of the first potential dip outside the cathode of the gas chamber, due to the enhanced strength of the electron layer, the region of the first potential dip having a minimum potential value at a center of the electron layer, wherein a first electric field is directed from the cathode towards the center of the electron layer, and a second electric field is directed from the anode towards the center of the electron layer.

7. The method of claim 5, wherein the method further comprises:
causing acceleration of negative charges and positive charges, the negative charges comprising the electrons and the negative ions, and the positive charges comprising the protons and the positive ions, wherein the negative charges are accelerated from the cathode towards the anode and the positive charges are accelerated from the anode towards the cathode, wherein the positive charges and the negative charges are accelerated in opposite directions and have a velocity difference; and
causing the electron-ion two-stream instability within the gas chamber, due to the velocity difference between the positive charges and the negative charges.

8. The method of claim 7, wherein the method further comprises:
causing acceleration of the negative charges towards the cathode, at each of the plurality of dips, to cause the cathode to emit the set of secondary electrons, and
causing acceleration of the positive charges towards the cathode, at each of the plurality of peaks, to bombard into the cathode, wherein the bombardment of the accelerated protons and the positive ions into the cathode occurs with a kinetic energy.

9. The method of claim 8, wherein the kinetic energy of each charged particle bombarding into the cathode is in a range of 1 keV to 100 keV.

10. The method of claim 1, wherein the method further comprises:
applying a heating source across the gas chamber to perform at least: the heating of the cathode, and ionization of the neutral gas into the protons and the electrons, wherein
the heating source comprises at least one of: superconducting magnet source, permanent magnet source, electromagnet source, radiofrequency (RF) source, microwave source, electric field source, electrode source, laser source, ion gun source, or a combination thereof.

11. The method of claim 1, wherein a diameter of the conducting channel is in a range of 0.01 millimeters to 1 millimeter.

12. The method of claim 1, wherein a density of the neutral gas is in a range of 1×10²⁰ to 1×10²⁵ m⁻³.

13. The method of claim 1, wherein the neutral gas comprises at least hydrogen (H₂) gas.

14. The method of claim 1, wherein the gas chamber is energized by externally applying a voltage in a range of 10 Volts to 1000 Volts.

15. The method of claim 1, wherein the cathode comprises a boron rich material, the boron-rich material comprising at least one of: lanthanum hexaboride (LaB₆), cerium hexaboride (CeB₆), lithium boride, pure boron, or boron nitride, and
wherein the cathode provides boron for the controlled fusion reaction.

16. An apparatus for performing a controlled fusion reaction, the apparatus comprising:
a gas chamber comprising an anode and a cathode enclosed within the gas chamber, and a neutral gas distributed within the gas chamber; and
an energy source configured to supply energy to the gas chamber, wherein the supply of the energy causes to:
initiate at least: heating of the cathode, and ionization of the neutral gas into protons and electrons;
form a conducting channel, due to the ionized neutral gas;
form an electron layer outside an outer surface of the cathode, based on a set of thermionically emitted electrons by the heated cathode;
accelerate the electrons from the ionized neutral gas towards the cathode, due to a potential associated with the electron layer, to cause the heated cathode to emit a set of secondary electrons, wherein the set of secondary electrons enhance a strength of the electron layer; and
form an electrostatic potential profile within the conducting channel due to an electron-ion two-stream instability, the electrostatic potential profile comprising a plurality of dips and a plurality of peaks, wherein the protons from the ionized neutral gas are accelerated towards the cathode at the plurality of potential peaks and bombardment of the accelerated protons into the cathode enables the controlled fusion reaction.

17. The apparatus of claim 16, wherein the supply of the energy further causes to:
heat the cathode and ionize the neutral gas, due to an initial discharge current; and
form a first potential dip of the plurality of potential dips, due to the set of thermionically emitted electrons by the heated cathode.

18. The apparatus of claim 17, wherein the supply of the energy further causes to:
accelerate the electrons between a region associated with the first potential dip and the cathode to bombard the cathode, wherein the region lies between the anode and the cathode;
emit the set of secondary electrons by the cathode, due to the bombardment of the accelerated electrons at the cathode;
strengthen the electron layer, at the first potential dip of the plurality of potential dips, due to the set of secondary electrons emitted by the cathode; and
form the electrostatic potential profile within the conducting channel, due to the strengthened electron layer, the conducting channel with the electrostatic potential profile being associated with the formation of the enhanced electron layer and the strengthened first potential dip.

19. The apparatus of claim 16, wherein the supply of the energy further causes to:
partially ionize the neutral gas to generate a plasma, the plasma comprising the protons, the electrons, positive ions, and negative ions;
accelerate the electrons and the negative ions towards the cathode to cause the bombarded cathode to emit the set of secondary electrons to enhance the strength of the electron layer;
form a region of the first potential dip outside the cathode of the gas chamber, due to the enhanced strength of the electron layer, the region of the first potential dip having a minimum potential value at a center of the electron layer, wherein a first electric field is directed from the cathode towards the center of the electron layer, and a second electric field is directed from the anode towards the center of the electron layer;
accelerate negative charges and positive charges, the negative charges comprising the electrons and the negative ions, and the positive charges comprising the protons and the positive ions, wherein the negative charges are accelerated from the cathode towards the anode and the positive charges are accelerated from the anode towards the cathode, wherein the positive charges and the negative charges are accelerated in opposite directions and have a velocity difference; and
form the electron-ion two-stream instability within the gas chamber, due to the velocity difference between the positive charges and the negative charges.

20. The apparatus of claim 19, wherein the supply of the energy further causes to:
accelerate the negative charges towards the cathode, at each of the plurality of dips, to cause the cathode to emit the set of secondary electrons; and
accelerate the positive charges towards the cathode, at each of the plurality of peaks, to bombard into the cathode, wherein the bombardment of the accelerated protons and the positive ions into the cathode causes generation of a kinetic energy.
